(19) United States
(12) Patent Application Publication
(10) Pub. No.: US 2016/0277158 A1
(43) Pub. Date: Sep. 22, 2016

(54) DATA COMMUNICATIONS TROUBLESHOOTING DEVICE

(71) Applicant: Terry Brown, Monaca, PA (US)

(72) Inventor: Terry Brown, Monaca, PA (US)

(21) Appl. No.: 14/658,375

(22) Filed: Mar. 16, 2015

(51) Int. Cl. H04L 1/24; G06F 11/263; H04L 12/26; G06F 13/40

(52) U.S. Cl. CPC H04L 1/242; G06F 13/4022; G06F 11/263; H04L 43/50

(57) ABSTRACT

A data communications troubleshooting device isolates the direction of signal interference relative to a cable splitter. The device includes a panel and a plurality of connection ports coupled to the panel. Each of the connection ports is positioned such that the panel replaces a signal splitter positioned in a splitter housing. The connection ports include an input port and a plurality of output ports. Each of a plurality of switches is coupled to an associated one of the output ports to selectively prevent transmission of a signal between the input port and the output port whereby signal loss is detectable as being related to a specific one of the output ports through manipulation of the switches.

### BACKGROUND OF THE DISCLOSURE

### Field of the Disclosure

The disclosure relates to troubleshooting devices and more particularly pertains to a new troubleshooting device for isolating the direction of signal interference relative to a cable splitter.

### SUMMARY OF THE DISCLOSURE

An embodiment of the disclosure meets the needs presented above by generally comprising a panel and a plurality of connection ports coupled to the panel. Each of the connection ports is positioned such that the panel replaces a signal splitter positioned in a splitter housing. The connection ports include an input port and a plurality of output ports. Each of a plurality of switches is coupled to an associated one of the output ports to selectively prevent transmission of a signal between the input port and the output port whereby signal loss is detectable as being related to a specific one of the output ports through manipulation of the switches.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a data communications troubleshooting device according to an embodiment of the disclosure.

FIG. 2 is a rear view of an embodiment of the disclosure.

FIG. 3 is a front view of a splitter housing used with an embodiment of the disclosure.

FIG. 4 is a rear view of a splitting unit replaced by an embodiment of the disclosure during use.

FIG. 5 is a schematic view of an embodiment of the disclosure.

### DESCRIPTION OF THE PREFERRED EMBODIMENT

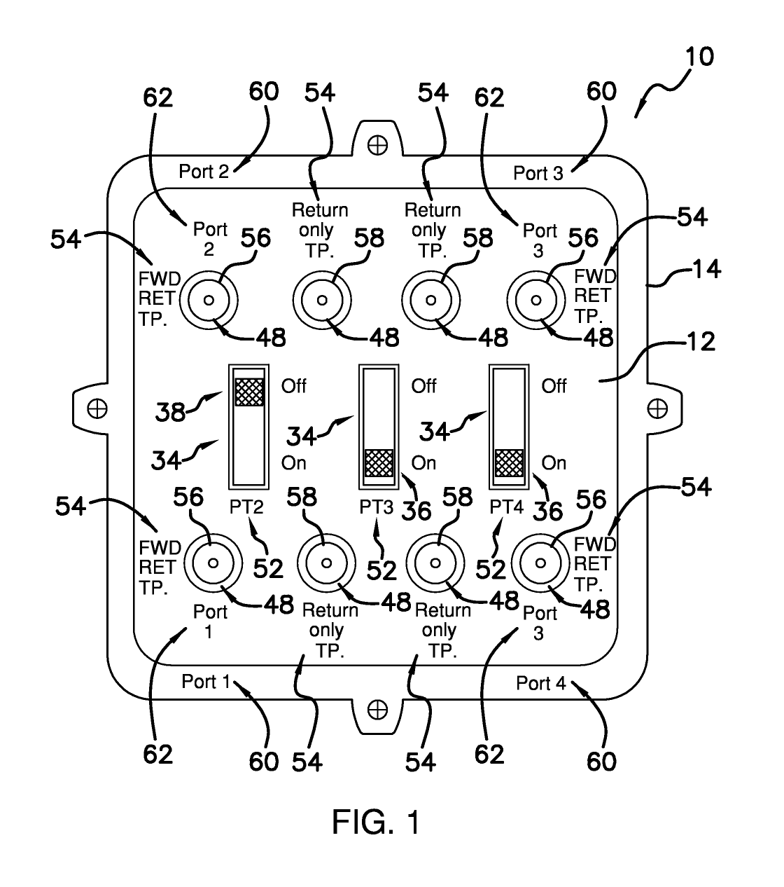

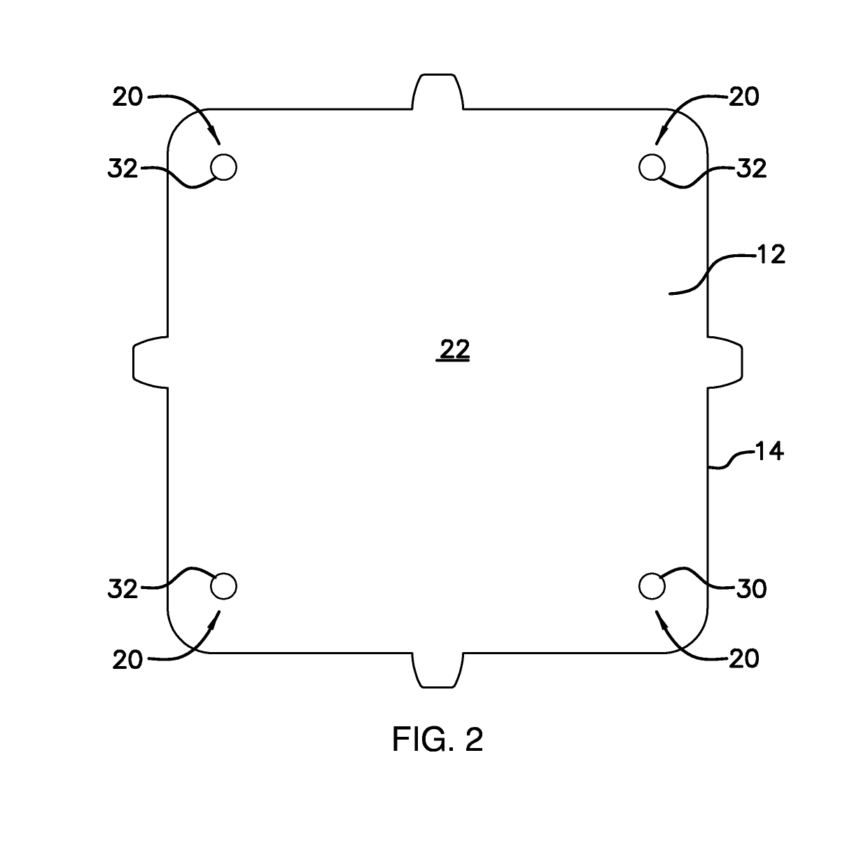

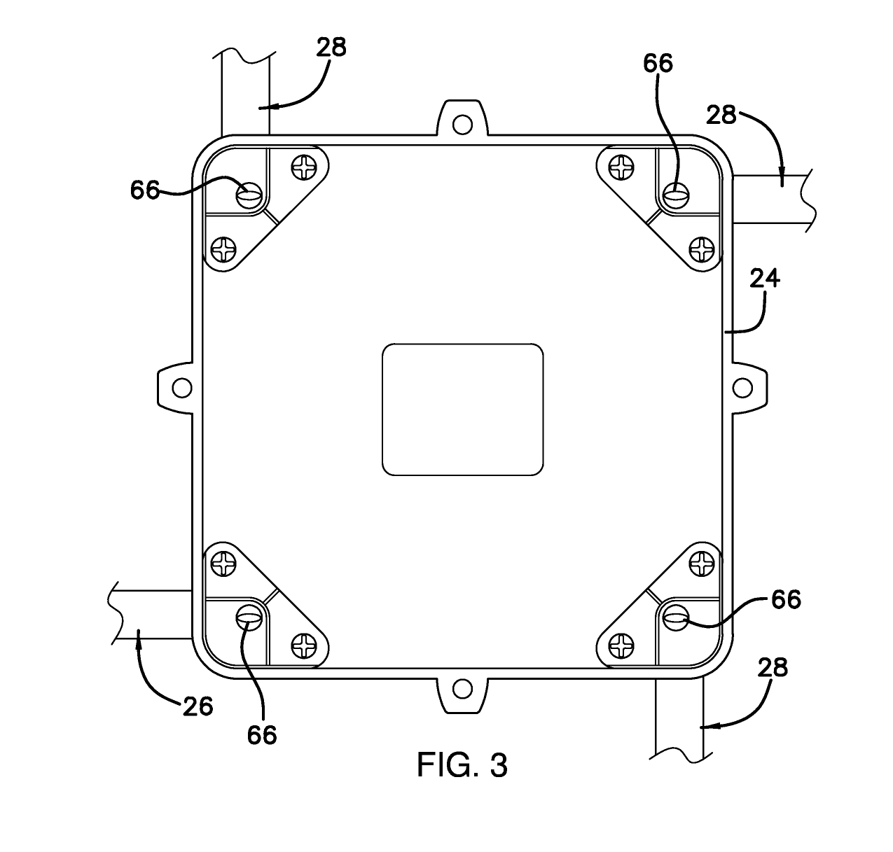

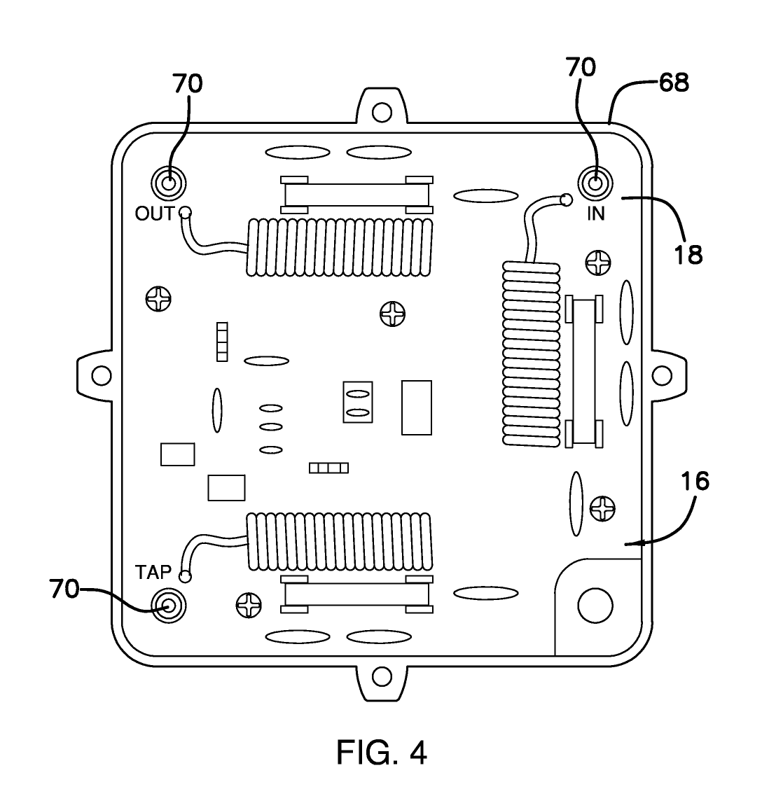

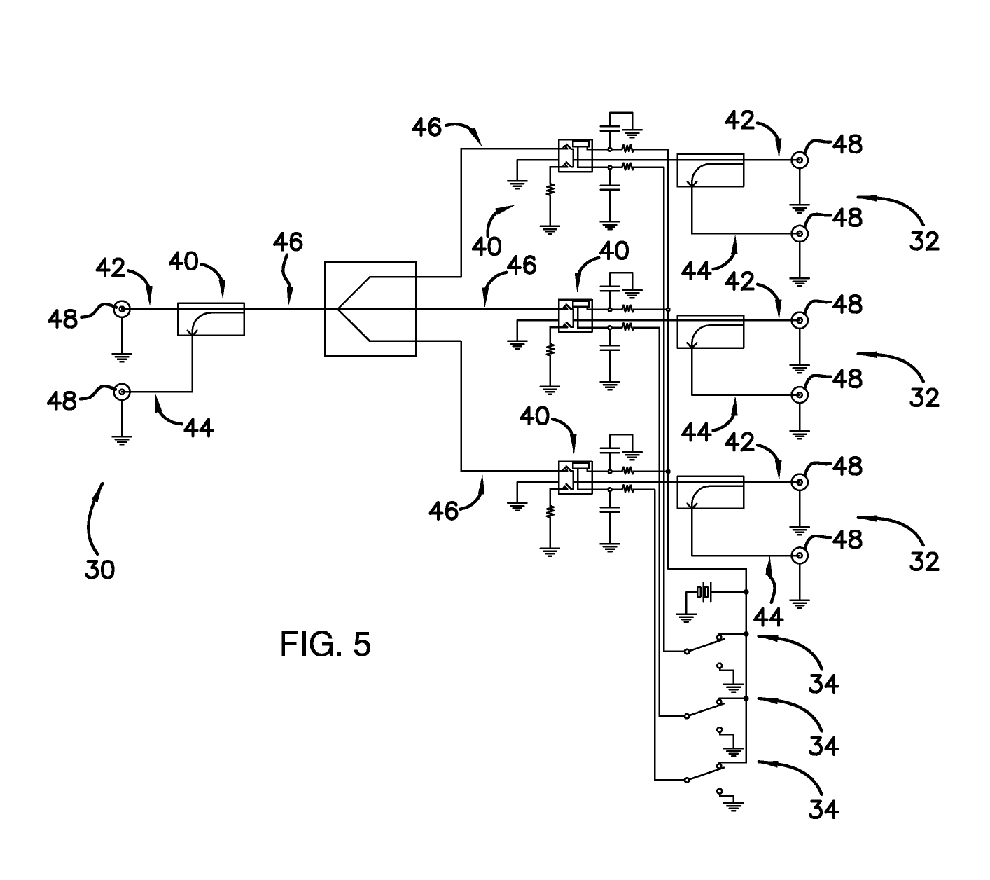

With reference now to the drawings, and in particular to FIGS. 1 through 5 thereof, a new troubleshooting device embodying the principles and concepts of an embodiment of the disclosure and generally designated by the reference numeral 10 will be described.

As best illustrated in FIGS. 1 through 5, the data communications troubleshooting device 10 generally comprises a panel 12 having a perimeter edge 14. The perimeter edge 14 is shaped such that the panel 12 is configured to correspond to a shape of a signal splitter 16 of a specific brand of signal splitting unit 18. Each brand commonly used has a unique shape which may be mimicked by the shape of the panel 12. Current cable television systems typically employ one or more of only a few brands of splitting units 18 such that a significant percentage of signal splitting units 18 in use can be tested using only a few variations in the shape of the panel 12.

Each of a plurality of connection ports 20 is coupled to the panel. The connection ports 20 are positioned on a back face 22 of the panel 12 and further positioned such that the panel 12 is configured to replace the signal splitting unit 18 positioned in a splitter housing 24. The typical splitter housing 24 provides a hardwired port 26 for incoming data and multiple outgoing hardwired ports 28. The signal splitting unit 18 comprises a faceplate 68 which connects to the splitter housing 24 and existing internal posts 66, or the like, by connectors 70 allowing the signal splitting unit 18 to split the incoming signal and divert the signal transmission to each of the outgoing hardwired ports 26. The panel 12 replaces the signal splitting unit 18 connecting to the hardwired ports 26,28 in the same manner as the faceplate. The plurality of connection ports 20 includes an input port 30 and a plurality of output ports 32.

Each of a plurality of switches 34 is coupled to the panel 12. Each of the switches 34 is coupled to an associated one of the output ports 32 wherein each switch 34 selectively allows and prevents transmission of a signal between the input port 32 and the associated one of the output ports 34. Thus, signal loss is detectable as being related to a specific one of the output ports 34 through manipulation of the switches 34. Each of the switches 34 has an on position 36 in which the switch 34 connects transmission from the input port 30 to the associated one of the output ports 32. Each of the switches 34 has an off position 38 in which the switch 34 disconnects transmission from the input port 30 to the associated one of the output ports 32. Thus, manipulation of the switches 34, as opposed to unsplicing and resplicing of cables, allows isolation of signal transmission through each output port 32 to determine which output port 32 leads to interference or impedance. The device 10 is used to trace a path to a source of signal interference by successive use from a signal origin point through successive signal splitting units 18.

Each of a plurality of diplex filters 40 is coupled to an associated one of the connection ports 20. Each of the diplex filters 40 isolates a forward return signal 42 and a return only signal 44 within a data stream 46 through the associated connection port 20. Each of a plurality of testing ports 48 is coupled to the panel 12 and coupled to an associated one of the diplex filters 40. Each testing port 48 is configured for coupling to an extrinsic testing unit 50 of conventional design for isolating signal problems within each of the forward return signals 42 and the return only signals 44.

Switch indicia 52 is positioned on the panel 12 labeling each of the switches 34 as corresponding to the associated one of the output ports 32. Return indicia 54 is positioned on the panel 12 labeling each of the testing ports 48 as corresponding to one of a forward return testing port 56 and a return only testing port 58. Connection port indicia 60 is positioned on the panel 12 labeling each connection port 20 with a unique identifier. Connection return indicia 62 is positioned on the panel 12 labeling an associated one of the return only testing ports 58 and an associated one of the forward return testing ports 56 as corresponding to a specific one of the connection ports 20. Thus, testing of data transmission, including isolated forward return signals 42 and return only signals 44, when each output port 32 is active is simplified.

In use, the panel 12 replaces the signal splitting unit 18. Each output port 32 is deactivated by manipulation of the associated switch 34. When interference disappears, a technician knows the interference or impedance is occurring downstream from the deactivated output port 32. The technician may then repeat the process to isolate the location and source of interference or impedance. The data transmission system may remain active for substantially longer periods of time resulting in less signal downtime due to splicing, unsplicing, and resplicing of hardwired connections to perform the same type of testing process for isolating interference or impedance.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A data communications troubleshooting device comprising:
a panel;
a plurality of connection ports coupled to said panel, each of said connection ports being positioned such that said panel is configured to replace a signal splitter positioned in a splitter housing, said plurality of connection ports including an input port and a plurality of output ports; and
a plurality of switches coupled to said panel, each of said switches being coupled to an associated one of said output ports wherein each switch selectively allows and prevents transmission of a signal between said input port and said associated one of said output ports whereby signal loss is detectable as being related to a specific one of said output ports through manipulation of said switches.

2. The device of claim 1, further comprising:
a plurality of diplex filters, each diplex filter being coupled to an associated one of said connection ports, each of said diplex filters isolating a forward return signal and a return only signal within a data stream through said associated connection port; and
a plurality of testing ports, each said testing port being coupled to said panel, each said testing port being coupled to an associated one of said diplex filters such that each said testing port is configured for coupling to an extrinsic testing unit for isolating signal problems within each of said forward return signals and said return only signals.

3. The device of claim 1, further comprising said panel having a perimeter edge, said perimeter edge being shaped such that said panel is configured to correspond to the signal splitter of a specific brand of signal splitting unit.

4. The device of claim 1, further comprising each of said switches having an on position in which said switch connects transmission from said input port to said associated one of said output ports, each of said switches having an off position in which said switch disconnects transmission from said input port to said associated one of said output ports.

5. The device of claim 1, further comprising switch indicia on said panel, said switch indicia labeling each of said switches as corresponding to said associated one of said output ports.

6. The device of claim 2, further comprising return indicia on said panel, said return indicia labeling each of said testing ports as corresponding to one of a forward return testing port and a return only testing port.

7. The device of claim 1, further comprising connection port indicia positioned on said panel, said connection port indicia labeling each said connection port with a unique identifier.

8. The device of claim 6, further comprising connection return indicia positioned on said panel, said connection return indicia labeling an associated one of said return only testing ports and an associated one of said forward return testing ports as corresponding to a specific one of said connection ports.

9. A data communications troubleshooting device comprising:
a panel, said panel having a perimeter edge, said perimeter edge being shaped such that said panel is configured to correspond to a shape of a signal splitter of a specific brand of signal splitting unit;
a plurality of connection ports coupled to said panel, each of said connection ports being positioned such that said panel is configured to replace the signal splitter positioned in a splitter housing, said plurality of connection ports including an input port and a plurality of output ports;
a plurality of switches coupled to said panel, each of said switches being coupled to an associated one of said output ports wherein each switch selectively allows and prevents transmission of a signal between said input port and said associated one of said output ports whereby signal loss is detectable as being related to a specific one of said output ports through manipulation of said switches, each of said switches having an on position in which said switch connects transmission from said input port to said associated one of said output ports, each of said switches having an off position in which said switch disconnects transmission from said input port to said associated one of said output ports;
a plurality of diplex filters, each diplex filter being coupled to an associated one of said connection ports, each of said diplex filters isolating a forward return signal and a return only signal within a data stream through said associated connection port; and
a plurality of testing ports, each said testing port being coupled to said panel, each said testing port being coupled to an associated one of said diplex filters such that each said testing port is configured for coupling to an extrinsic testing unit for isolating signal problems within each of said forward return signals and said return only signals;
switch indicia on said panel, said switch indicia labeling each of said switches as corresponding to said associated one of said output ports;
return indicia on said panel, said return indicia labeling each of said testing ports as corresponding to one of a forward return testing port and a return only testing port;
connection port indicia positioned on said panel, said connection port indicia labeling each said connection port with a unique identifier; and
connection return indicia positioned on said panel, said connection return indicia labeling an associated one of said return only testing ports and an associated one of said forward return testing ports as corresponding to a specific one of said connection ports.
